(19) United States
(12) Patent Application Publication
(10) Pub. No.: US 2007/0035501 A1
(43) Pub. Date: Feb. 15, 2007

(54) Voltage converting unit and display device having the same

(75) Inventor: Sang-Moon Moh, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/500,057

(22) Filed: Aug. 7, 2006

(30) Foreign Application Priority Data
Aug. 9, 2005 (KR) 2005-0072790

(51) Int. Cl. G09G 3/36

(52) U.S. Cl. 345/98

(57) ABSTRACT

A voltage converting unit includes a converting module part, a temperature compensating part, a first gate driving signal generating part and a second gate driving signal generating part, whereby an image display quality is improved. The converting module part generates a gate driving pulse based on an externally provided voltage. The temperature compensating part generates a reference voltage based on a primary reference voltage with respect to a temperature. The first gate driving signal generating part generates a first gate driving signal based on the gate driving pulse and the reference voltage. The second gate driving signal generating part generates a second gate driving signal based on the gate driving pulse and a ground voltage.

### CROSS-REFERENCE TO RELATED APPLICATION

The present application claims priority from Korean Patent Application No. 2005-72790, filed on Aug. 9, 2005, the disclosure of which is hereby incorporated herein by reference in its entirety.

### BACKGROUND OF THE INVENTION

1. Technical Field

The present disclosure relates to a voltage converting device and a display device having the voltage converting device. More particularly, the present disclosure relates to a voltage converting device capable of resisting being affected by a temperature variation, and a display device having the voltage converting device, which is capable of improving an image display quality.

2. Discussion of the Related Art

A display device displays an image using an electric signal that is processed by an information processing device. A flat panel display device is one of the display devices that has various characteristics; such as small size, light weight, high resolution, etc.

A liquid crystal display (LCD) device is one of the flat panel display devices that displays the image using electrical and optical characteristics of liquid crystals.

The LCD device includes a display panel assembly and a backlight assembly. The display panel assembly includes an LCD panel having an array substrate, an opposite substrate and a liquid crystal layer. The array substrate includes a switching element that is a thin film transistor (TFT). The opposite substrate opposes the array substrate. The liquid crystal layer is interposed between the array substrate and the opposite substrate.

The display panel assembly further includes a data printed circuit board, a data tape carrier package (TCP) and a gate TCP. The data printed circuit board generates a driving signal for driving the LCD panel. The data printed circuit board is electrically connected to the LCD panel through the data TCP. The gate TCP is electrically connected to gate lines of the array substrate.

The data TCP includes a data driving chip electrically connected to data lines of the array substrate. The gate TCP includes a gate driving chip electrically connected to the gate lines of the array substrate. The LCD panel may include a shift register having the gate driving chip, a level shifter and a buffer that are directly formed thereon so that a separate gate TCP is omitted.

The data printed circuit board generates a data driving signal and a gate driving signal. The data driving signal is applied to the LCD panel. The data driving signal is applied to the data TCP.

The backlight assembly supplies the LCD panel with light having a uniform luminance.

The display device further includes a panel driving member for driving the display panel assembly, which is capable of improving an image display quality.

The panel driving member includes a timing controlling part, a gray-scale voltage generating part and a power supplying part. The timing controlling part controls a driving of the display panel assembly. The gray-scale voltage generating part generates a plurality of reference gray-scale voltages. The power supplying part generates a plurality of driving voltages having various levels.

The levels of the driving voltages that are required for the panel driving member are different from each other, so that the power supplying part requires a voltage converting unit.

Electric characteristics of amorphous silicon TFT vary in response to a temperature of the amorphous silicon TFT. For example, the electrical characteristics of the amorphous silicon TFT at a temperature of about 27° C. are different from the electrical characteristics of the amorphous silicon TFT at a temperature of about 60° C. In addition, when the temperature of the amorphous silicon TFT is low, such as about −2° C., the amorphous silicon TFT is seriously deteriorated.

### SUMMARY OF THE INVENTION

Exemplary embodiments of the present invention provide a voltage converting device capable of resisting a temperature variation and a display device having the above-mentioned voltage converting device.

A voltage converting unit in accordance with an exemplary embodiment of the present invention includes a converting module part, a temperature compensating part, a first gate driving signal generating part and a second gate driving signal generating part. The converting module part generates a gate driving pulse based on an externally provided voltage. The temperature compensating part generates a reference voltage based on a primary reference voltage with respect to a temperature. The first gate driving signal generating part generates a first gate driving signal based on the gate driving pulse and the reference voltage. The second gate driving signal generating part generates a second gate driving signal based on the gate driving pulse and a ground voltage.

The temperature compensating part may include a first voltage controlling part and a second voltage controlling part. The first voltage controlling part may control a level of a constant voltage depending on a temperature to generate a first voltage. The second voltage controlling part may control a level of the primary reference voltage based on the first voltage to generate a second voltage.

The temperature compensating part may further include a step-up transforming circuit that increases a level of the second voltage.

The voltage converting unit may further include a driving voltage generating part that generates an analog-type driving voltage based on the gate driving pulse.

A display device includes a display panel, a panel driving part and a gate driving part. The display panel includes a display region in which a switching element is formed and a peripheral region surrounding the display region. The switching element is electrically connected to the data and gate lines. The panel driving part controls the display panel and generates a plurality of gate driving signals having different levels depending on a temperature of the panel driving part. The gate driving signals are applied to the gate driving part, and the gate driving part applies a plurality of gate signals to the gate lines based on the gate driving signals.

According to exemplary embodiments of the present invention, the driving characteristics of the display device are improved, even though a temperature of the display device is greatly changed. In addition, a variation of the gray-scale voltage is decreased to improve the image display quality of the display device.

### BRIEF DESCRIPTION OF THE DRAWINGS

Exemplary embodiments of the present invention can be understood in more detail from the following descriptions taken in conjunction with the accompanying drawings, in which:

FIG. 1 is a block diagram illustrating a display device in accordance with an exemplary embodiment of the present invention;

FIG. 2 is a plan view illustrating a display panel assembly in accordance with an exemplary embodiment of the present invention;

FIG. 3 is a plan view illustrating a display panel assembly in accordance with an exemplary embodiment of the present invention;

FIG. 4 is a block diagram illustrating a voltage converting unit in accordance with an exemplary embodiment of the present invention;

FIG. 5 is a circuit diagram illustrating a voltage converting unit in accordance with an exemplary embodiment of the present invention;

FIG. 6 is a circuit diagram illustrating a voltage converting unit in accordance with an exemplary embodiment of the present invention;

FIG. 7 is a graph illustrating a relationship between temperature and a voltage applied to a temperature compensating part; and

FIG. 8 is a graph illustrating a relationship between a voltage and a current of a diode in accordance with an exemplary embodiment of the present invention.

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

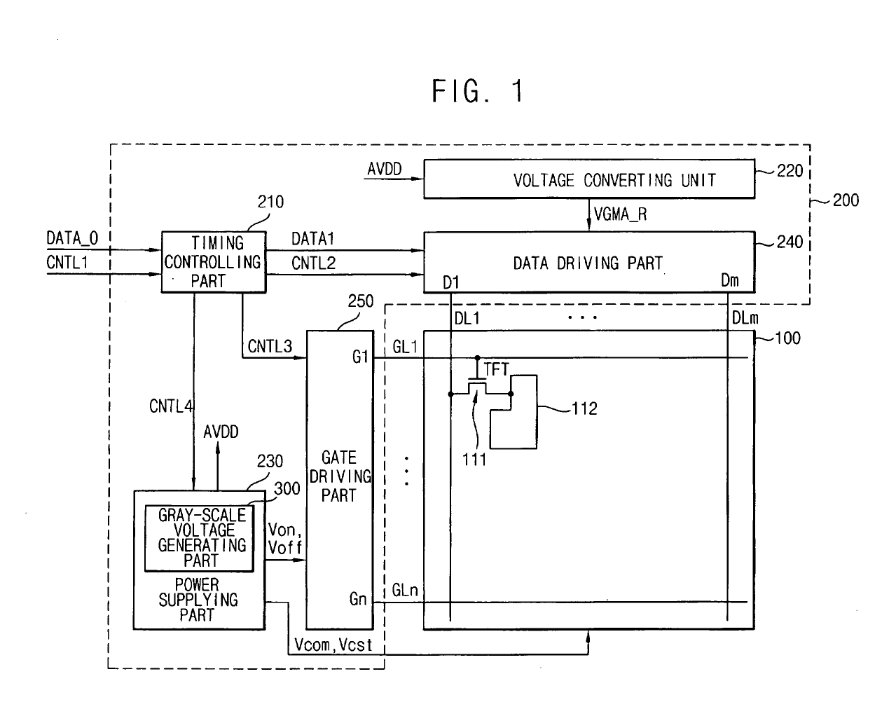

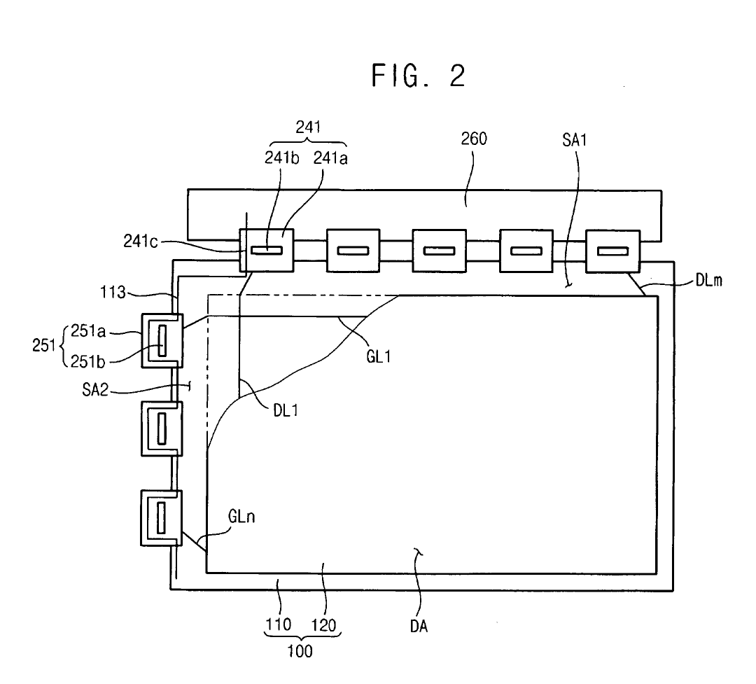

FIG. 1 is a block diagram illustrating a display device in accordance with an exemplary embodiment of the present invention. FIG. 2 is a plan view illustrating a display panel assembly in accordance with an exemplary embodiment of the present invention.

Referring to FIGS. 1 and 2, the display device includes a display panel 100 and a panel driving member 200.

The display panel 100 includes an array substrate 110, an opposite substrate 120 and a liquid crystal layer (not shown). The array substrate 110 includes a plurality of thin film transistors TFT that are arranged in a matrix shape. The opposite substrate 120 faces the array substrate 110. The liquid crystal layer (not shown) is interposed between the array substrate 110 and the opposite substrate 120.

The array substrate 110 includes a plurality of data lines DL and a plurality of gate lines GL. The data lines DL are extended in a row direction. The gate lines GL are extended in a column direction.

In FIGS. 1 and 2, ‘m’ represents a number of the data lines DL, and ‘n’ represents a number of the gate lines GL, wherein m and n are natural numbers. That is, the array substrate 110 includes first, second, . . . m-th data lines DL1, DL2, . . . DLm and first, second, . . . n-th gate lines GL1, GL2, . . . GLn.

Each of the thin film transistors TFT and each of pixel electrodes 112 are on a crossing portion on which each of the data lines DL1, DL2, . . . DLm crosses each of the gate lines GL1, GL2, . . . GLn. A gate electrode of each of the thin film transistors TFT 111 is electrically connected to one of the gate lines GL1, GL2, . . . GLn, and a source electrode of each of the thin film transistors TFT 111 is electrically connected to one of the data lines DL1, DL2, . . . DLm. A drain electrode of each of the thin film transistors TFT 111 is electrically connected to each of the pixel electrodes 112.

More specifically, a first thin film transistor and a first pixel electrode are on a crossing portion on which the first data line DL1 crosses the first gate line GLI. A gate electrode of the first thin film transistor TFT 111 is electrically connected to the first gate line GL1, and a source electrode of the first thin film transistor TFT 111 is electrically connected to the first data line DL1. A drain electrode of the first thin film transistor TFT 111 is electrically connected to the first pixel electrode 112.

The panel driving member 200 includes a timing controlling part 210, a gray-scale voltage generating part 220, a power supplying part 230, a data driving part 240 and a gate driving part 250.

The timing controlling part 210 controls the display device. The timing controlling part 210 generates a first data signal DATA1, a second control signal CNTL2, a third control signal CNTL3 and a fourth control signal CNTL4 based on a primary data signal DATA_0 and a first control signal CNTL1. The primary data signal DATA_0 and the first control signal CNTL1 are generated from a host system such as a graphic controller (not shown). The primary data signal DATA_0 includes red, green and blue image data R, G and B.

More specifically, the first control signal CNTL1 includes a main clock signal MCLK, a horizontal synchronizing signal HSYNC and a vertical synchronizing signal VSYNC. The second control signal CNTL2 includes a horizontal start signal STH, a reversion signal REV and a data load signal TP for controlling the data driving part 240. The third control signal CNTL3 includes a start signal STV, a clock signal CK and an output enable signal OE for controlling the gate driving part 250. The fourth control signal CNTL4 includes a clock signal CLK and a reversion signal REV for controlling the power supplying part 230.

The timing controlling part 210 applies the first data signal DATA1 to the data driving part 240 based on the primary data signal DATA_0. The first data signal DATA1 corresponds to timing controlled red, green and blue image data R′, G′and B′.

The gray-scale voltage generating part 220 generates a plurality of reference gray-scale voltages VGMA_R based on an analog-type driving voltage AVDD that is provided from the power supplying part 230 as a reference voltage. The reference gray-scale voltages VGMA_R correspond to a plurality of gray-scale levels based on a gamma curve using a plurality of voltage-divider resistors. For example, in an exemplary embodiment of the present invention, the number of the reference gray-scale voltages VGMA_R is five.

The power supplying part 230 applies common voltages Vcom and Vcst, a gate-on voltage Von, a gate-off voltage Voff and the analog-type driving voltage AVDD to the display panel 230. The power supplying part 230 may further include a voltage converting unit 300.

The voltage converting unit 300 may include a voltage converting part, a voltage converting circuit, a voltage converting device, etc.

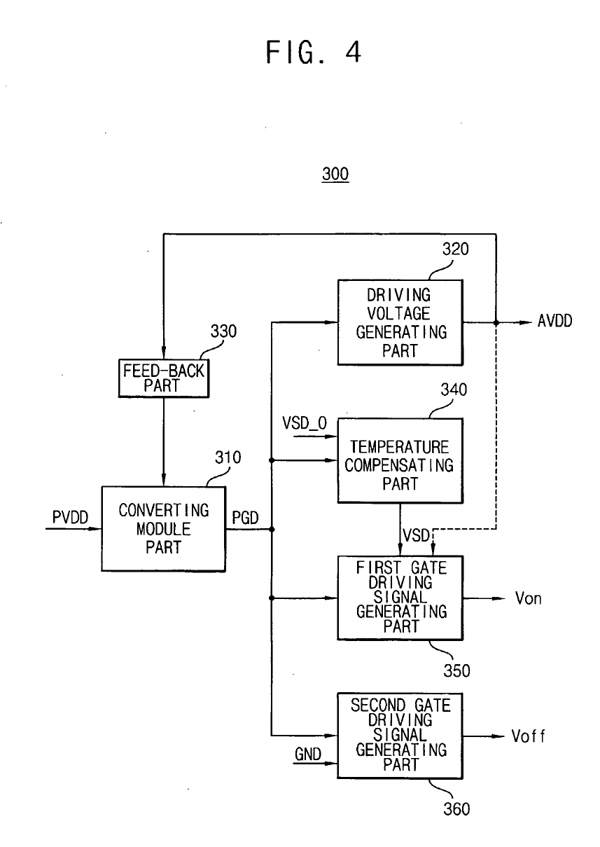

The voltage converting unit 300 will be described in connection with FIGS. 4 to 10.

The data driving part 240 may include a data tape carrier package (TCP) 241. The data TCP 241 includes a data flexible circuit film 241a and a data driving chip 241b.

The data flexible circuit film 241a is electrically connected to a first region SA1 of a peripheral region SA of the display panel 100 through an anisotropic conductive film ACF. The display panel 100 includes a display region DA and the peripheral region SA that surrounds the display region DA.

The thin film transistors 111 and the pixel electrodes 112 are in the display region DA. The peripheral region SA surrounds the display region DA of the display panel 100.

The data flexible circuit film 241a generates data signals D1, D2, . . . Dm and a data driving signal for driving the display panel 100. The data signals are based on the first data signal DATA1 and the reference gray-scale voltages VGMA_R that are outputted from the gray-scale voltage generating part 220. For example, the data signals D1, D2, . . . Dm may be digital-type signals. Alternatively, the data signals D1, D2, . . . Dm may be analog-type signals. The data flexible circuit film 241a may include a circuit pattern formed thereon.

The data driving chip 241b is mounted on the data flexible circuit film 241a.

The data driving chip 241b generates a gray-scale voltage VGMA based on the reference gray-scale voltages VGMA_R that are outputted from the gray-scale voltage generating part 220. In addition, the data driving chip 241b controls a timing of the data signals D1, D2, . . . Dm to apply the data signals D1, D2, . . . Dm to the data lines DL1, DL2, . . . DLm, respectively, based on the first data signal DATA1 and the gray-scale voltage VGMA. The first data signal DATA1 is a digital-type.

The data driving chip 241b may include a gamma string (not shown) and a digital-analog converter (not shown). The gamma string (not shown) divides the reference gray-scale voltage VGMA_R based on the gamma curve. The digital-analog converter (not shown) converts the first data signal DATA1 into the analog-type data signals D1, D2, . . . Dm.

The data driving part 240 may further include a plurality of data tape carrier packages 241 so that the data lines DL1, DL2, . . . DLm are grouped into a plurality of blocks.

The gate driving part 250 includes a gate TCP 251. The gate TCP 251 includes a gate flexible circuit film 251a and a gate driving chip 25lb.

The gate flexible circuit film 251a is electrically connected to a second region SA2 of the peripheral region SA through an anisotropic conductive film (ACF). The peripheral region SA surrounds the display region DA of the display panel 100.

The gate flexible circuit film 251a applies a gate driving signal to the gate driving chip 251b. The gate flexible circuit film 251a may include a circuit pattern to transmit the gate signals G1, G2, . . . Gn that are generated from the gate driving chip 251b to the display panel 100.

The gate driving chip 251b is mounted on the gate flexible circuit film 251a to control a timing of the gate signals G1, G2, . . . Gn, so that the gate signals G1, G2, . . . Gn are applied to the gate lines GL1, GL2, . . . GLn, respectively.

The gate driving part 250 may further include a plurality of gate tape carrier packages 421, so that the gate lines GL1, GL2, . . . GLm are grouped into a plurality of blocks.

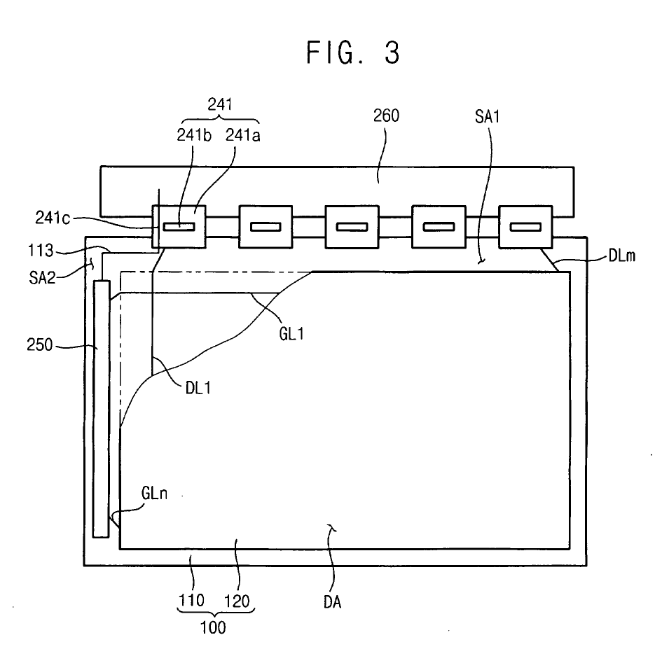

FIG. 3 is a plan view illustrating a display panel assembly in accordance with an exemplary embodiment of the present invention.

Referring to FIGS. 1 to 3, a gate driving part 250 is directly integrated on a display panel 100. That is, the gate driving part 250 is formed in a second region SA2 of a peripheral region SA of the display panel 100.

The gate driving chip 251b (shown in FIG. 2) may include a shift register, a level shifter and a buffer to apply gate signals G1, G2, . . . Gn to gate lines GL1, GL2, . . . GLn, respectively, so that the gate lines GL1, GL2, . . . GLn are activated in sequence. The gate driving chip 251b has a simpler structure than the data driving chip 241b (shown in FIG. 2).

That is, the gate driving part 250 may include a gate driving circuit that performs substantially the same function as the gate driving chip 251b (shown in FIG. 2), and is directly integrated in the second region SA2 of an array substrate 110 of the display panel 100. Therefore, a size of the display panel assembly is decreased, and a manufacturing process of the display panel assembly may be simplified.

Alternatively, when the gate driving part 250 is directly integrated on the display panel 100, the gate signals G1, G2, . . . Gn−1 of previous stages may be used as a clock signal, so that the third control signal CNTL3 need not include the clock signal CK.

The display device may further include a data printed circuit board 260. The data printed circuit board 260 is electrically connected to the array substrate 110 through a data TCP 241. The data printed circuit board 260 may include a timing controlling part 210, a gray-scale voltage generating part 220 and a power supplying part 230. The data printed circuit board 260 generates a data driving signal for driving the data driving part 240 and a gate driving signal for driving the gate driving part 250.

In FIG. 3, the display panel assembly may further include a plurality of data tape carrier packages 241, and one of the data tape carrier packages 241 includes a metal line 241c to transmit the gate driving signal to the array substrate 110. In addition, the array substrate 110 may further include a metal line 113 for transmitting the gate driving signal that is from the data printed circuit board 260 to the gate driving part 250.

In FIG. 3, the gate driving signal is generated from the data printed circuit board 260 and is applied to the gate driving part 250 through the metal lines 241c and 113. Alternatively, the display panel assembly may further include a gate TCP 251 (shown in FIG. 2), and the gate driving signal may be generated from a gate printed circuit board (not shown) that is attached to one end portion of the gate TCP 251 (shown in FIG. 2).

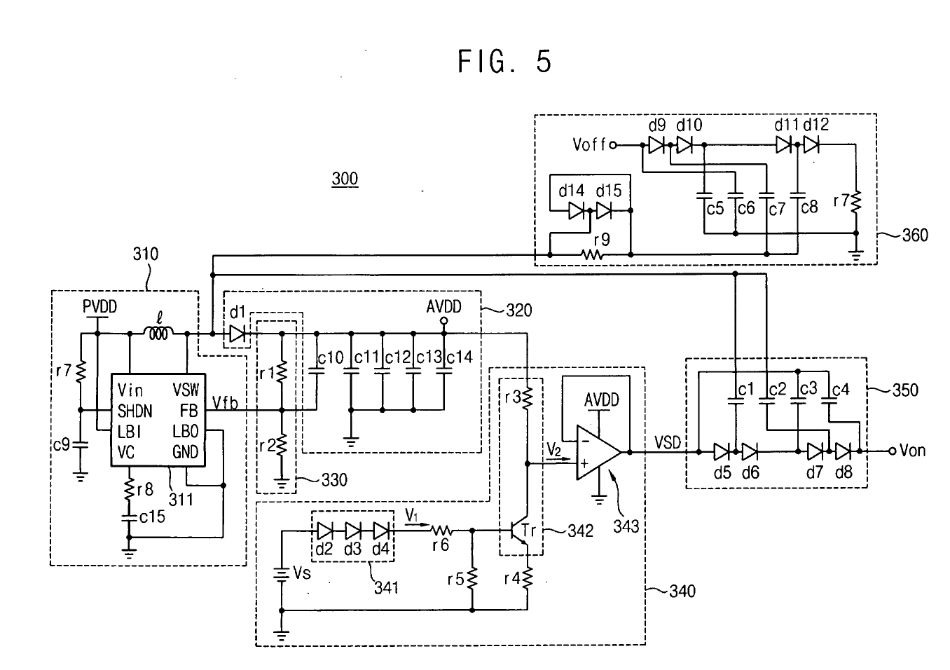

FIG. 4 is a block diagram illustrating a voltage converting unit in accordance with an exemplary embodiment of the present invention. FIG. 5 is a circuit diagram illustrating a voltage converting unit in accordance with an exemplary embodiment of the present invention.

Referring to FIGS. 4 and 5, the voltage converting unit 300 includes a converting module part 310, a driving voltage generating part 320, a feed-back part 330, a temperature compensating part 340, a first gate driving signal generating part 350 and a second gate driving signal generating part 360.

The converting module part 310 receives an externally provided voltage PVDD and includes a converting module 311. The converting module 311 may be composed of one chip. The converting module part 310 generates a gate driving pulse PGD based on an inductance L formed by an operation of a switching element of the converting module 311.

The switching element of the converting module part 310 may be an N-channel metal oxide semiconductor (NMOS) transistor.

The driving voltage generating part 320 commutates the gate driving pulse PGD using a diode d1 to generate the analog-type driving voltage AVDD.

The feed-back part 330 includes a plurality of resistors r1 and r2 that are electrically connected in series. The resistors r1 and r2 divide the analog-type driving voltage AVDD to apply a feed-back signal Vfb to the converting module 311.

The converting module 311 compares the feed-back signal Vfb with a reference signal Vref that is predetermined in the converting module 311 to selectively increase an amplitude of the gate driving pulse PGD. For example, when the level of the feed-back signal Vfb is smaller than the level of the reference signal Vref, the converting module 311 increases the amplitude of the gate driving pulse PGD to maintain the level of the gate driving pulse PGD with respect to the reference signal Vref.

In addition, when the level of the feed-back signal Vfb is greater than the level of the reference signal Vref, the converting module 311 decreases the amplitude of the gate driving pulse PGD to maintain the level of the gate driving pulse PGD with respect to the reference signal Vref.

That is, the converting module part 310 maintains the amplitude of the gate driving pulse PGD using the feed-back signal Vfb that is outputted from the feed-back part 330 to maintain the level of the analog-type driving voltage AVDD that is outputted from the driving voltage generating part 320.

The temperature compensating part 340 increases the amplitude of the gate driving pulse PGD at low temperatures to compensate driving characteristics of the thin film transistors that are electrically connected to the gate lines of the display panel 100 (shown in FIG. 2).

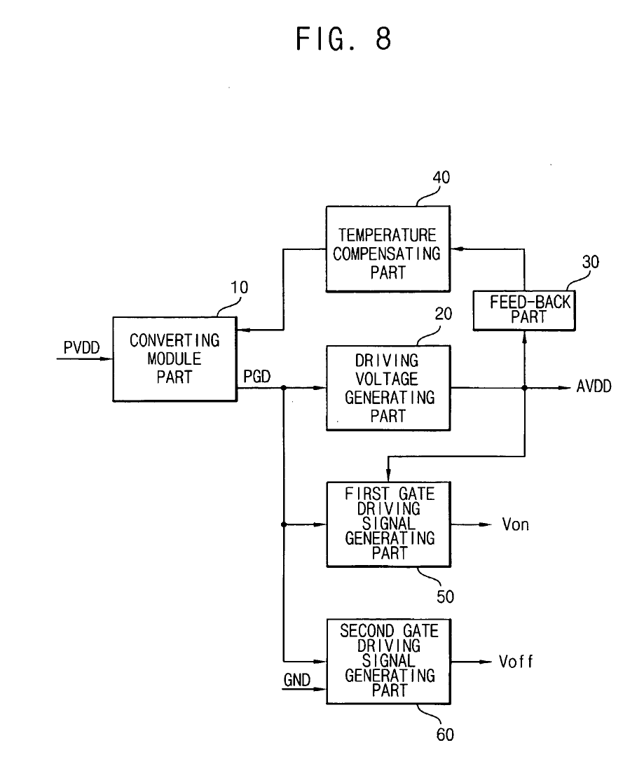

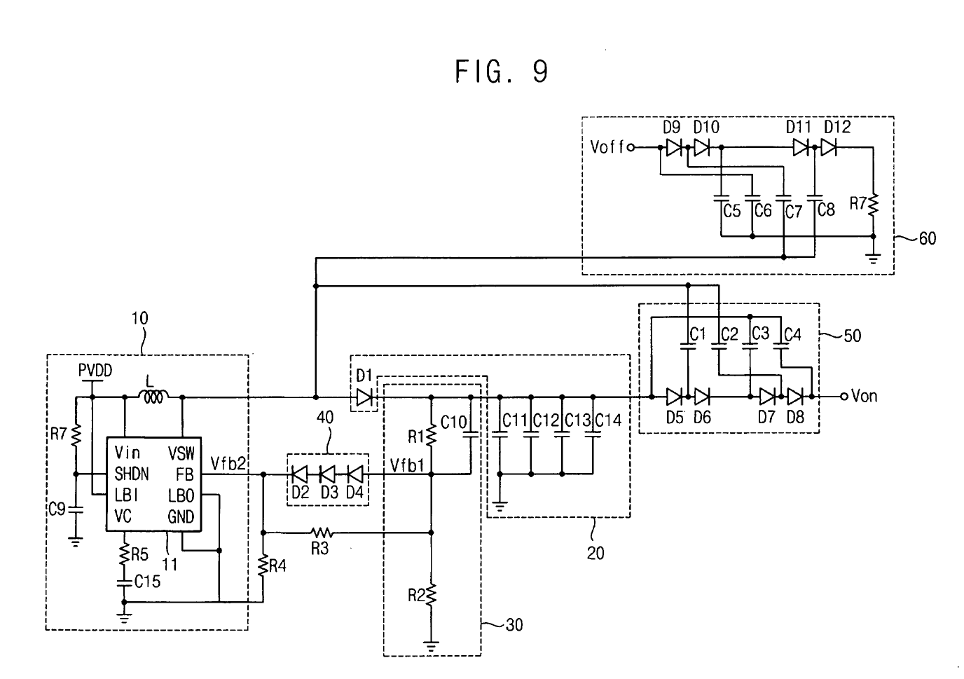

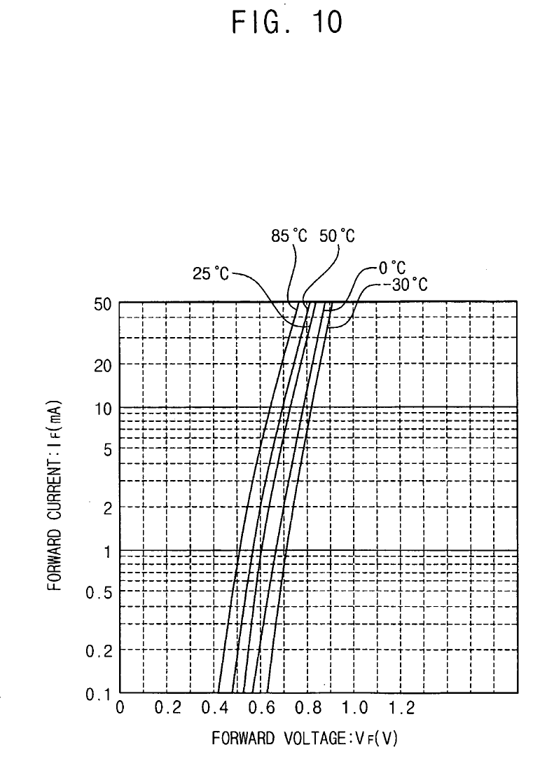

FIG. 8 is a graph illustrating a relationship between a voltage and a current of a diode in accordance with an exemplary embodiment of the present invention.

Referring to FIG. 8, when a current flowing through diodes is about 0.1 mA, voltage drops of each of the diodes at a temperature of about 85° C. and a temperature of about −30° C. are about 0.4V and about 0.6V, respectively.

FIG. 4 is a block diagram illustrating a voltage converting unit in accordance with an exemplary embodiment of the present invention. FIG. 5 is a circuit diagram illustrating a voltage converting unit in accordance with an exemplary embodiment of the present invention.

Referring to FIGS. 4 and 5, a temperature compensating part 340 controls a primary reference voltage VSD_0 based on a temperature to generate a reference voltage VSD. In addition, the temperature compensating part 340 includes a first voltage controlling part 341 and a second voltage controlling part 342.

For example, the first voltage controlling part 341 includes a plurality of diodes d2, d3 and d4 that receives a constant voltage Vs. The diodes d2, d3 and d4 decrease a level of the constant voltage Vs to apply the constant voltage Vs having the decreased level to the second voltage controlling part 342.

The second voltage controlling part 342 may include a transistor Tr that is electrically connected to the first voltage controlling part 342. A first electrode, which is a base electrode B of the transistor Tr, is electrically connected to the first voltage controlling part 342. A second electrode, which is a collector electrode C of the transistor Tr, receives the primary reference voltage VSD_0. A third electrode, which is an emitter electrode E of the transistor Tr, is electrically connected to a ground electrode GND.

The level of the constant voltage Vs is decreased by the diodes d2, d3 and d4, and the decreased level of the constant voltage Vs may be substantially the same as a summation of a voltage drop formed among the diodes d2, d3 and d4 and the transistor Tr and a threshold voltage of the transistor Tr.

In FIGS. 4 and 5, the primary reference voltage VSD_0 is the analog-type driving voltage AVDD.

The first voltage controlling part 341 decreases a level of the constant voltage Vs based on the temperature of the voltage converting unit 300 using a plurality of diodes d2, d3 and d4 to control a level of a voltage applied to the base electrode B. Thus, a collector current ic that flows the second voltage controlling part 342 is controlled by the level of the voltage applied to the base electrode B.

That is, an amount of the collector current ic is increased, as the level of the voltage applied to the base electrode B is increased. In addition, the amount of the collector current ic is decreased, as the level of the voltage applied to the base electrode B is decreased.

For example, when the amount of the collector current ic and the temperature of the voltage converting unit 300 are small and low, respectively, and when the first voltage controlling part 341 greatly decreases the level of the constant voltage Vs, a voltage applied to a resistor r3 that is electrically connected to the collector C to receive the analog-type driving voltage is decreased by Ohm's Law. Thus, a level of a collector voltage Vc is increased.

In addition, when the amount of the collector current ic and the temperature of the voltage converting unit 300 are large and high respectively and when the first voltage controlling part 341 slightly decreases the level of the constant voltage Vs, the voltage applied to the resistor r3 that is electrically connected to the collector C to receive the analog-type driving voltage is increased by Ohm's Law. Thus, the level of the collector voltage Vc is decreased.

The temperature compensating part 340 may further include a step-up transforming circuit 343.

The step-up transforming circuit 343 is electrically connected to the second voltage controlling part 342. In particular, the step-up transforming circuit 343 is electrically connected to the collector C of the transistor Tr.

In FIGS. 4 and 5, an output impedance of the collector C is large, so that the step-up transforming circuit 343 adjusts the output impedance to improve an operation of the first gate driving signal generating part 350 that is electrically connected to the temperature compensating part 340. In addition, the step-up transforming circuit 343 amplifies the second voltage V2 to generate a reference signal VSD. The step-up transforming circuit 343 may include an operational amplifier (Op-amp). Alternatively, the step-up transforming circuit 343 may include a buffer.

The first gate driving signal generating part 350 generates a first gate driving signal Von based on the reference voltage VSD and the gate driving pulse PGD using a plurality of diodes d5, d6, d7 and d8 and a plurality of capacitors c1, c2, c3 and c4 as a charge pumping circuit. The reference voltage VSD is outputted from the temperature compensating part 340. The gate driving pulse PGD is outputted from the converting module part 310.

The second gate driving signal generating part 360 generates a second gate driving signal Voff based on the gate driving pulse PGD using a plurality of diodes d9, d10, d11 and d12 and a plurality of capacitors c5, c6, c7 and c8 as a charge pumping circuit. The gate driving pulse PGD is outputted from the converting module part 310 based on a ground voltage GND. A plurality of diodes d14 and d15 and a resistor r17 that are between the converting module part 310 and the second gate driving signal generating part 360 adjust an amplitude of the gate driving pulse PGD to apply the adjusted gate driving pulse PGD to the second gate driving signal generating part 360.

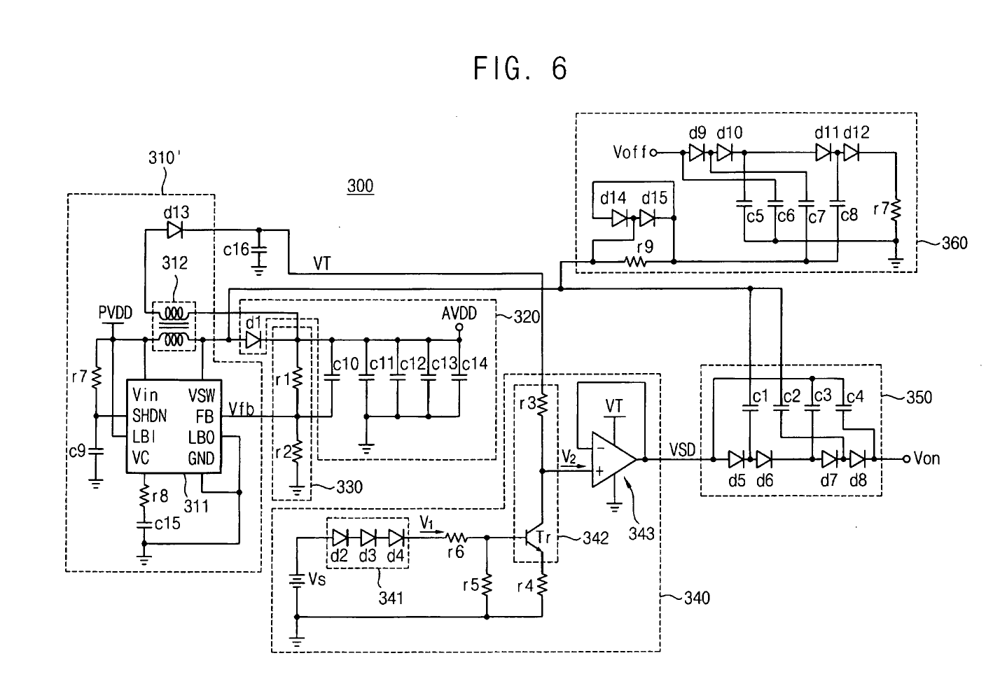

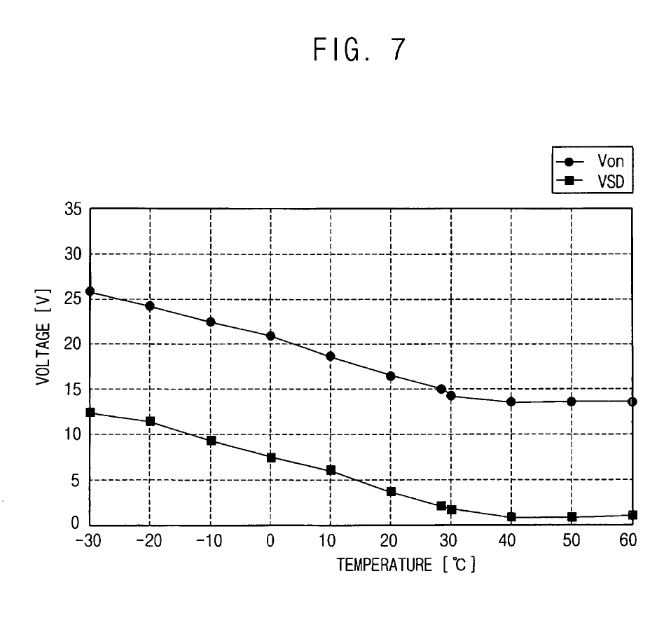

FIG. 6 is a circuit diagram illustrating a voltage converting unit in accordance with an exemplary embodiment of the present invention. FIG. 7 is a graph illustrating a relationship between a temperature and a voltage applied to a temperature compensating part.

Referring to FIGS. 6 and 7, the voltage converting unit 300 includes a converting module part 310′, a driving voltage generating part 320, a feed-back part 330, a temperature compensating part 340, a first gate driving signal generating part 350 and a second gate driving signal generating part 360. The voltage converting unit of FIGS. 6 and 7 is substantially the same as in FIG. 5, except for a converting module part. Thus, the same reference numerals will be used to refer to the same or like parts as those described in FIG. 5 and any further explanation concerning the above elements will be omitted.

The converting module part 310′ receives an externally provided voltage PVDD and includes a converting module 311. The converting module 311 may be composed of one chip. The converting module part 310′ generates a gate driving pulse PGD through an operation of a switching element of the converting module 311.

The converting module part 310′ may further include a transforming circuit 312.

The transforming circuit 312 includes a transformer having a first winding electrically connected to the converting module part 310′ and a second winding electrically connected to the temperature compensating part 340.

The first winding is electrically connected to the converting module part 310′ to generate a gate driving pulse PGD using an inductance formed by an operation of a switching element of the converting module 311.

An output voltage VT is induced by the first and second windings of the transformer to be outputted from the second winding. The output voltage VT is commutated by a diode d13 to apply a primary reference voltage VSD_0 to the temperature compensating part 340.

The driving voltage generating part 320 commutates the gate driving pulse PGD using a diode d1 to generate an analog-type driving voltage AVDD.

The feed-back part 330 includes a plurality of resistors r1 and r2 that are electrically connected in series. The resistors r1 and r2 divide the analog-type driving voltage AVDD to apply a feed-back signal Vfb to the converting module 311.

The feed-back part of FIGS. 6 and 7 is same as in FIG. 5. Thus, the same reference numerals will be used to refer to the same or like parts as those described in FIGS. 5 and any further explanation concerning the above elements will be omitted.

The temperature compensating part 340 controls the primary reference voltage VSD_0 based on a temperature to generate a reference voltage VSD. In addition, the temperature compensating part 340 includes a first voltage controlling part 341 and a second voltage controlling part 342.

For example, the first voltage controlling part 341 includes a plurality of diodes d2, d3 and d4 that receives a constant voltage Vs. The diodes d2, d3 and d4 decrease a level of the constant voltage Vs to apply a first voltage V1 having the decreased level to the second voltage controlling part 342.

The second voltage controlling part 342 may include a transistor Tr that is electrically connected to the first voltage controlling part 342. A first electrode, which is a base electrode B of the transistor Tr, is electrically connected to the first voltage controlling part 342. A second electrode, which is a collector C of the transistor Tr, receives the primary reference voltage VSD_0. A third electrode, which is an emitter E of the transistor Tr, is electrically connected to a ground electrode GND. In FIGS. 6 and 7, the primary reference voltage VSD_0 may be the output voltage VT that is outputted from the transforming circuit 312.

The transforming circuit 312 of the voltage converting unit 300 may generate the primary reference voltage VSD_0 that may be the output voltage VT outputted from the transforming circuit 312. Alternatively, the primary reference voltage VSD_0 may be an externally provided constant voltage.

A charge pumping circuit (not shown) may be electrically connected to the first gate driving signal generating part 350 in series, to increase a level of the first gate driving signal Von to feed back the first gate driving signal Von having the increased level. Thus, the feed-backed signal may be the primary reference voltage VSD_0. Alternatively, the primary reference voltage VSD_0 may be generated in various methods.

In FIGS. 6 and 7, the primary reference voltage VSD_0 has a greater level than the analog-typed driving voltage AVDD.

In FIGS. 6 and 7, the primary reference voltage VSD_0 has a greater level than the analog-type driving voltage AVDD to increase the maximum variation of the reference voltage VSD that is between the primary reference voltage having a greater level than the analog-typed driving voltage AVDD and the ground voltage GND.

Referring again to FIG. 10, the level of the first gate driving signal Von is changed, as the level of the reference voltage VSD is changed. Thus, the level of the first gate driving signal Von may be increased with reference to a variation of the temperature, even though the temperature is greatly increased, thereby improving driving characteristics of the display device. That is, the level of the first gate driving signal Von may be determined with reference to the temperature.

The temperature compensating part of FIGS. 6 and 7 is substantially same as in FIG. 5 except for the primary reference voltage VSD_0 that has the greater level than the analog-type driving voltage AVDD. The first and second gate driving signal generating parts of FIGS. 6 and 7 are substantially same as in relation to FIG. 5. Thus, the same reference numerals will be used to refer to the same or like parts as those described in FIG. 5 and any further explanation concerning the above elements will be omitted.

According to the voltage converting unit shown in FIGS. 1 to 10, the level of the primary reference voltage is changed with respect to the variation of the temperature to compensate the driving characteristics of the thin film transistor of the display panel, thereby improving the driving characteristics of the display panel. The driving characteristics of the thin film transistor are changed, as the temperature is changed.

According to exemplary embodiment of the present invention, the level of the primary reference voltage that is applied to the display panel is determined with respect to the temperature, thereby improving an image display quality of the display device.

In addition, the variation of the gray-scale voltage is decreased so that the level of the output voltage of the data driving chip is not increased to protect the output pad, thereby increasing the yield of the display device. In addition, the life of the output pad may also be increased.

Furthermore, the variation of the gray-scale voltage is decreased, thereby decreasing a power consumption of the display device.

Also, the analog-type driving voltage is electrically independent from the gate driving signal, so that the level of the gate driving signal may be easily adjusted. Therefore, the driving characteristics of the display device are increased at a high temperature or a low temperature.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A voltage converting unit comprising:
a converting module part generating a gate driving pulse based on an externally provided voltage;
a temperature compensating part generating a reference voltage based on a primary reference voltage with respect to a temperature;
a first gate driving signal generating part that generates a first gate driving signal based on the gate driving pulse from the converting module and the reference voltage from the temperature compensating part; and
a second gate driving signal generating part that generates a second gate driving signal based on the gate driving pulse from the converting module and a ground voltage.

2. The voltage converting unit of claim 1, wherein the temperature compensating part comprises:
a first voltage controlling part that controls a level of a constant voltage based on a temperature to generate a first voltage; and
a second voltage controlling part that controls a level of the primary reference voltage based on the first voltage to generate a second voltage.

3. The voltage converting unit of claim 2, wherein the temperature compensating part further comprises a step-up transforming circuit that increases a level of the second voltage.

4. The voltage converting unit of claim 3, wherein the step-up transforming circuit comprises an operational amplifier.

5. The voltage converting unit of claim 2, wherein the first voltage controlling part comprises an electric element, and a threshold voltage of the electric element is changed with respect to a temperature of the electric element.

6. The voltage converting unit of claim 5, wherein the electric element comprises a diode.

7. The voltage converting unit of claim 5, wherein the electric element comprises a plurality of diodes that are electrically connected to each other in series.

8. The voltage converting unit of claim 2, wherein the second voltage controlling part comprises a transistor.

9. The voltage converting unit of claim 8, wherein the transistor comprises:
a first electrode electrically connected to the first voltage controlling part;
a second electrode receiving the primary reference voltage; and
a third electrode receiving the ground voltage.

10. The voltage converting unit of claim 1, further comprising a driving voltage generating part that generates an analog-type driving voltage based on the gate driving pulse.

11. The voltage converting unit of claim 10, wherein the primary reference voltage is the analog-type driving voltage.

12. The voltage converting unit of claim 10, wherein the primary reference voltage has a greater level than the analog-type driving voltage to increase a level of the first gate driving signal.

13. The voltage converting unit of claim 12, wherein the primary reference voltage is an external voltage that is externally provided to the voltage converting unit.

14. The voltage converting unit of claim 12, further comprising a transforming circuit generating the primary reference voltage based on the gate driving pulse.

15. A display device comprising:
a display panel including a display region, in which a switching element is formed, and a peripheral region surrounding the display region, the switching element being electrically connected to data lines and gate lines;
a panel driving part that controls the display panel, the panel driving part generating a plurality of gate driving signals based on a temperature of the panel driving part; and
a gate driving part applying a plurality of gate signals to the gate lines based on the plurality of gate driving signals.

16. The display device of claim 15, wherein the gate driving part is located in the peripheral region.

17. The display device of claim 15, wherein the plurality of gate driving signals comprises:
a first gate driving signal that turns on the switching element; and
a second gate driving signal that turns off the switching element.

18. The display device of claim 17, wherein the panel driving part decreases a level of each of the first gate driving signals when the temperature of the panel driving part is greater than a reference temperature, and the panel driving part increases the level of each of the first gate driving signals when the temperature of the panel driving part is smaller than the reference temperature.

19. The display device of claim 15, wherein the panel driving part comprises a voltage converting unit including:
a converting module part generating a gate driving pulse based on an externally provided voltage;
a temperature compensating part generating a reference voltage based on a primary reference voltage with respect to the temperature;
a first gate driving signal generating part that generates a first gate driving signal based on the gate driving pulse and the reference voltage; and
a second gate driving signal generating part that generates a second gate driving signal based on the gate driving pulse and a ground voltage.

20. The display device of claim 19, wherein the voltage converting unit further comprises a driving voltage generating part that generates an analog-type driving voltage based on the gate driving pulse.

21. The display device of claim 20, wherein the panel driving part further comprises a gray-scale voltage generating part that generates a plurality of reference gray-scale voltages based on the analog-type driving voltage.

22. The display device of claim 21, wherein the panel driving part further comprises a data driving part that generates a plurality of gray-scale voltages based on the reference gray-scale voltages to apply a plurality of analog-type data signals to the data lines based on the gray-scale voltages and a plurality of digital-type data signals.
